(19) United States
(12) Patent Application Publication
(10) Pub. No.: US 2026/0132662 A1
(43) Pub. Date: May 14, 2026

(54) DOOR LOCKING DEVICE COMPRISING A NOTCHED SHAFT

(71) Applicant: SENTINEL, Villejust (FR)

(72) Inventors: Elhame LAROUI, Villejust (FR); Elias LAROUI, Villejust (FR)

(21) Appl. No.: 19/119,127

(22) PCT Filed: Oct. 9, 2023
(86) PCT No.: PCT/EP2023/077857

§ 371 Date: Apr. 8, 2025

(30) Foreign Application Priority Data
Oct. 13, 2022 (FR) FR2210511

(51) Int. Cl. E05C 17/54

(52) U.S. Cl. CPC E05C 17/54

(57) ABSTRACT

A door blocking device is configured to keep a door closed. The door blocking device includes a shaft with a first end designed to rest on the floor and a lever system that is translationally mobile relative to the shaft, the lever system including a tab designed to be positioned under the door and a handle equipped with a trigger connected to an actuation device to move the lever system relative to the shaft, the lever system including blocking means to lock it relative to the shaft and keep the door closed. The shaft includes multiple notches forming a notching, in the blocking position, the displacement element being designed to rest on one of the notches.

### BACKGROUND

### Technical Field

The invention relates to a door locking device for keeping a door closed.

### Discussion of the Background

When someone tries to force a door lock or force it open with a strong push (or force), the door usually gives way and opens.

The locking device allows you to block a door, whether or not it has a lock, to prevent any type of intrusion. The locking device provides additional protection by keeping a door locked and making it immobile to any form of pressure applied. The locking device allows leverage to be exerted between the door and the floor in order to make it immobile.

The locking device is particularly useful during an attack in a school, for example, where not all doors have locks or have weak locks. Once the children are grouped in a classroom, the locking device must allow the door to be blocked quickly.

There are locking devices such as that described in document FR3118983 comprising an shaft having a first end intended to rest on the ground and a lever system movable in translation relative to the shaft. The lever system comprises a tab intended to be positioned under the door and a handle equipped with a trigger connected to an actuating device to move the lever system relative to the shaft.

The actuating device comprises a displacement element held on the shaft by a spring and which is pivotable relative to the shaft between a rest position in which the displacement element is substantially perpendicular to the shaft so as to allow free translation of the lever system on the shaft and a locking position in which the displacement element is inclined non-perpendicularly relative to the shaft to move the lever system relative to the shaft.

The locking position is obtained by actuating the trigger causing the trigger to interact with the displacement element to tilt it non-perpendicularly to the shaft and lock it on the shaft. Prolonged actuation of the trigger causes the lever system to move relative to the shaft to lock the door.

The lever system also includes locking means to lock it relative to the shaft and keep the door closed.

However, locking doors with these prior art locking devices is not always ensured effectively because the moving element sometimes slides along the shaft instead of being locked on the shaft. This problem occurs more particularly when a fatty substance, such as oil for example, is present on the axle. This slippage results in a loss of time.

The aim of the invention is therefore to overcome the drawbacks of the prior art by proposing a locking device comprising a displacement element which does not slide along the shaft, even in the presence of oil, thus making it possible to lock the doors more effectively and more quickly than those of the prior art.

To do this, the invention thus relates, in its broadest sense, to a door locking device intended to keep a door closed comprising a shaft having a first end intended to rest on the ground and a lever system movable in translation relative to the shaft.

The lever system comprises a tab intended to be positioned under the door and a handle provided with a trigger connected to an actuating device for moving the lever system relative to the shaft in a direction for blocking the door.

The actuating device comprises a displacement element held on the shaft by return means. The displacement element is pivotable relative to the shaft between a rest position in which it is substantially perpendicular to the shaft so as to allow free translation of the lever system on the shaft and a locking position in which the displacement element is inclined non-perpendicularly relative to the shaft to move the lever system relative to the shaft.

The locking position is obtained by actuating the trigger causing a first end of the trigger to pivot towards the displacement element and pressure on an edge of the displacement element to tilt it non-perpendicularly relative to the shaft and lock it on the shaft. A prolonged actuation of the trigger causes the lever system to translate relative to the shaft towards the door locking direction by pushing the first end of the trigger onto the displacement element.

The lever system includes locking means to lock it relative to the shaft and keep the door closed.

According to the invention, the shaft comprises several notches forming a notch. In the locking position, the displacement element is intended to rest on one of the notches to prevent the displacement element from moving back in a direction opposite to the locking direction.

The invention thus provides a locking device comprising a notched shaft which is more effective than those of the prior art. The moving element does not slide along the shaft during the locking of a door, even in the presence of oil, in a faster manner.

The notches in effect provide a non-smooth locking surface on which the moving element is more effectively locked.

Alternatively, the notching is oriented in a direction opposite to the handle.

In another variant, the notching is oriented towards the handle.

According to another variant, the notching extends over 20% to 60% of the length of the shaft.

According to another variant, the notching comprises a central zone positioned between half and three-quarters of the length of the shaft, from the first end of the shaft.

This arrangement allows the position of the notches to be optimized in the most useful area to minimize manufacturing costs. The notches on the lower part of the axle are not used.

According to another variant, the shaft comprises a second end opposite the first end. The notch is closer to the second end than to the first end of the axle.

According to another variant, each notch has a depth of between 0.5 mm and 1.5 mm.

According to another variant, each notch has a width between 1 mm and 3 mm.

The size of the notches is advantageously small so that the notches are not felt during the locking of the door. The notches must not impede the moving element or create too much vibration when moving the moving element from one notch to another or increase the effort to move the shaft.

The size of the notches is not, however, too small to allow the movement element to be attached to the notches.

According to another variant, each notch comprises a first bearing face and a second bearing face forming a tooth angle of between 70° and 95°.

According to another variant, an angle is formed between a non-notched face of the shaft, adjacent to the first bearing face of the notch, and the first bearing face of the notch. The angle is between 60° and 80°.

### BRIEF DESCRIPTION OF THE DRAWINGS

Embodiments of the present invention will be described below, by way of non-limiting examples, with reference to the appended figures in which:

FIG. 1 schematically illustrates a side view of the interior of a door locking device at rest, according to the invention;

FIG. 2 schematically illustrates a profile view of a shaft of the door locking device of the FIG. 1;

FIG. 3 schematically illustrates a detailed view of a notch provided on the shaft;

FIG. 4 schematically illustrates a view of a door locking device comprising a magnetic plate supported by a metal bracket.

### DETAILED DESCRIPTION OF THE INVENTION

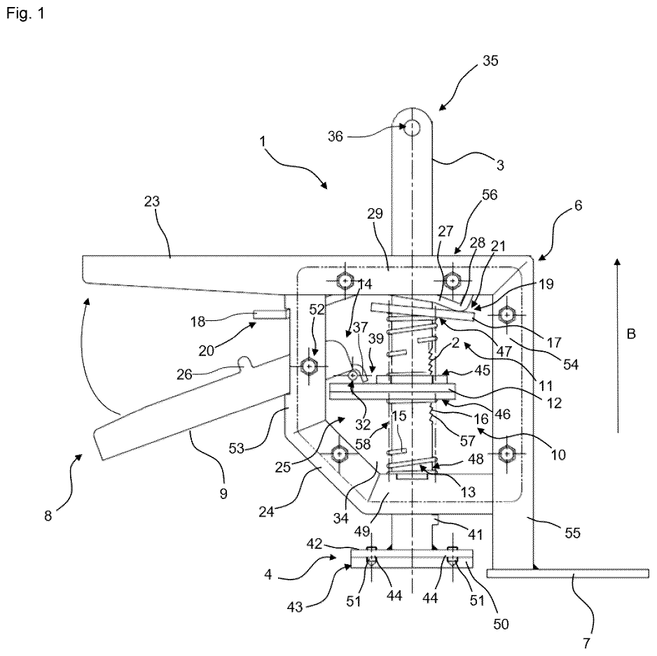

The FIG. 1 illustrates a door locking device 1 intended to keep a door closed, in the rest position.

The door locking device 1 comprises a shaft 3 having a first end 4 intended to rest on the ground 5 and a lever system 6 movable in translation relative to the shaft 3.

The lever system 6 comprises a tab 7 intended to be positioned under the door and a handle 8 provided with a trigger 9 connected to an actuating device 10 for moving the lever system 6 relative to the shaft 3 towards a blocking direction B of the door.

The actuating device 10 comprises a displacement element 12 held on the shaft 3 by return means 13 and which is pivotable relative to the shaft 3 between a rest position in which the displacement element 12 is substantially perpendicular to the shaft 3 so as to allow free translation of the lever system 6 on the shaft 3 and a locking position in which the displacement element 12 is inclined non-perpendicularly relative to the shaft 3 to move the lever system 6 relative to the shaft 3.

The locking position is obtained by actuating the trigger 9 causing a first end 14 of the trigger 9 to pivot towards the displacement element 12 and pressure on an edge 39 of the displacement element 12 to tilt it non-perpendicularly relative to the shaft 3 and lock it on the shaft 3.

Prolonged actuation of the trigger 9 causes the lever system 6 to translate relative to the shaft 3 towards the locking direction B of the door by pushing the first end 14 of the trigger 9 onto the displacement element 12.

The lever system 6 also includes locking means 11 intended to lock it relative to the shaft 3 to keep the door closed.

The lever system 6 comprises a structure 24 provided with an internal housing 25 crossed by the shaft 3 and in which are housed the displacement element 12, the return means 13 and the blocking means 11 which are also crossed by the shaft 3.

The return means 13 comprise a compression spring 15 positioned around the shaft 3. The return means 13 advantageously comprise a single compression spring 15.

The displacement element 12 has an orifice in which the shaft 3 slides. The displacement element 12 is held around the shaft 3 between a first turn and a second turn of the compression spring 15 (not shown to simplify the FIG. 1).

The first turn is in contact with a first face 45 of the displacement element 12 and the second turn is in contact with a second face 46 of the displacement element 12.

The displacement element 12 is positioned in the middle of the compression spring 15. The displacement element 12 can also be offset relative to the middle of the compression spring 15.

The displacement element 12 has a substantially flat shape. Its orifice is delimited by a rim which engages with the shaft 3 when the trigger 9 is activated.

Alternatively, the return means 13 may comprise two springs, including a first compression spring and a second compression spring positioned around the shaft 3 (not shown). The displacement element 12 is held around the shaft 3 between the first and second compression springs.

Shaft 3 has a longitudinal shape with a rectangular section. Other sections are possible such as square, circular or hexagonal sections.

The shaft 3 comprises at least one protuberance 41 on one of its faces and forming a stop for the structure 24.

The locking means 11 comprise a lever 18 and a locking element 17 comprising an orifice in which the shaft 3 slides. The locking element 17 is held around the shaft 3 between the compression spring 15 and the lever 18 and more precisely between a first end 47 of the compression spring 15 and the lever 18. The compression spring 15 comprises a second end 48 bearing on a lower structural element 49 of the structure 24.

The blocking element 17 is pivotable relative to the shaft 3 between a locking position in which it is inclined non-perpendicularly relative to the shaft 3 to block the translation of the lever system 6 when the actuating device 10 is not actuated and an unlocking position when the blocking element 17 is substantially perpendicular to the shaft 3 so as to allow the free translation of the lever system 6 towards the blocking direction B of the door when the actuating device 10 is actuated.

The locking element 17 has a substantially flat shape. Its orifice is delimited by a rim which engages with the shaft 3 to block it when the trigger 9 is not activated.

The displacement element 12 and the blocking element 17 operate in an antagonistic manner. When one is engaged with shaft 3, the other is released from shaft 3.

The lever 18 comprises a first end 19 intended to engage on an edge 21 of the locking element 17 to keep it pivoted and locked relative to the shaft 3 and a second end 20 opposite the first end 19. The movement of the second end 20 towards the trigger 9 and therefore in a direction opposite to the locking direction B of the door, causes the lever 18 to be released from the edge 21, then the locking element 17 to pivot into the unlocking position.

The locking element 17 is no longer engaged with the shaft 3. The displacement element 12 is engaged with the shaft 3. The lever system 6 can then slide along the shaft 3 in a direction opposite to the locking direction B of the door towards the first end 4 of the shaft 3, allowing the removal of the tab 7 from under the door which is thus unlocked. The door locking device 1 can then be removed.

The lever 18 comprises a first curved portion 27 bearing against an upper structural element 29 of the structure 24 and a second curved portion 28 bearing against the edge 21 of the locking element 17 to keep it pivoted. The first 27 and the second curved part 28 are positioned inside the internal housing 25. The second end of the lever 20 is positioned outside the internal housing 25.

Preferably, the handle 8 comprises a fixed gripping portion 23. The trigger 9 comprises a lug 26 positioned opposite the gripping part 23. Pivoting the trigger 9 towards a locking position and towards the gripping part 23 causes the lug 26 to push onto the second end of the lever 20. The first end of the lever 19 then exerts pressure on the edge 21 of the locking element 17 to keep it pivoted non-perpendicular to the shaft 3 and to lock the lever system 6 relative to the shaft 3.

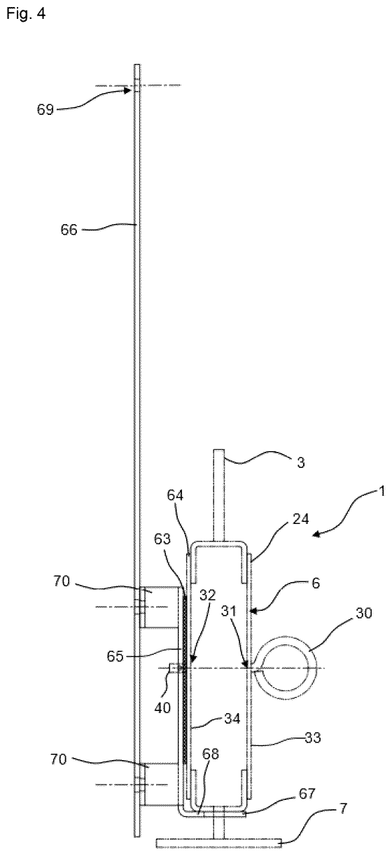

The door locking device 1 comprises a locking element 30, as illustrated in FIG. 4, for holding the trigger 9 in a locking position.

The locking element 30 is preferably a pin 30, as illustrated in the FIG. 4, comprising a rod 40 inserting into a first orifice 31 provided in a first side wall 33 of the structure 24 of the lever system 6 and into a second orifice 32 provided on a second side wall 34 of the structure 24 of the lever system 6. The rod 40 passes transversely through the internal housing 25 and comes to bear against the first end 14 of the trigger 9 to block its pivoting.

The first end 4 of the shaft 3 comprises a foot 42 provided with an anti-slip means 43 comprising at least one point 44 intended to engage with the ground 5.

Preferably, the foot 42 comprises four points 44.

The tips 44 may be cylinders comprising a conical or pyramidal head 51 directed towards the ground 5 or may be nails, for example.

The spikes 44 are intended to grip the ground 5 to prevent the foot 42 from slipping. The 44 tips are particularly effective when the floor 5 is made of wood or polymer.

The foot 42 has a flat shape parallel to the ground 5 when placed on it. The anti-slip means 43 comprises a flexible pad 50 arranged under the foot 42 to be in contact with the ground 5 and improve grip.

The flexible pad 50 may be made of foam and be composed of ethylene-propylene-diene monomer (EPMD), for example. The flexible pad 50 is preferably made of polyurethane.

The head 51 of the tips 44 is housed in the flexible pad 50.

When the door locking device 1 is not in use and there is no pressure on the foot 42, the head 51 of the spikes 44 remains housed in the flexible pad 50. Thus, children can operate the door locking device 1 without being injured by the spikes 44.

In contrast, when the door locking device 1 is used to lock a door, pressure is exerted on the flexible pad 50 which compresses and causes the heads 51 to spring out of the spikes so that the heads 51 engage with the floor 5.

Alternatively (not shown), the foot 42 of the shaft 3 comprises cylindrically shaped support elements made of polyurethane resting on the ground to prevent the foot 42 from slipping. The foot 42 may have four support elements, for example.

The shaft 3 comprises a second end 35 provided with an orifice 36 intended to receive a half-ring, for example, to limit the movement of the lever system 6 in the locking direction B of the door. In the low position of the foot 42, the half-ring comes to rest on a portion 56 extending the gripping part 23.

This provides a simple solution to prevent the axle 3 from protruding from the internal housing 25 of the lever system 6.

As illustrated in the FIG. 1, the first end 14 of the trigger 9 is extended by a curved element 37 like a hook, making it possible to improve the engagement on the displacement element 12.

The structure 24 forms a rigid frame, preferably made of metal, comprising the upper structural element 29, the lower structural element 49, a rear structural element 53 and a front structural element 54.

The internal housing 25 is closed by the first side wall 33 and the second side wall 34.

The trigger 9 is movable in rotation around an axis 52 arranged in the rear structural element 53 of the structure 24. The trigger 9 can pivot through an angle of 37°, for example, between its rest position and its locking position.

The gripping part 23 is connected to the tab 7 by a structural element 55 parallel to the shaft 3, the gripping part 23 and the tab 7 being perpendicular to the structural element 55.

The gripping portion 23 and the structural element 55 are fixed to the structure 24.

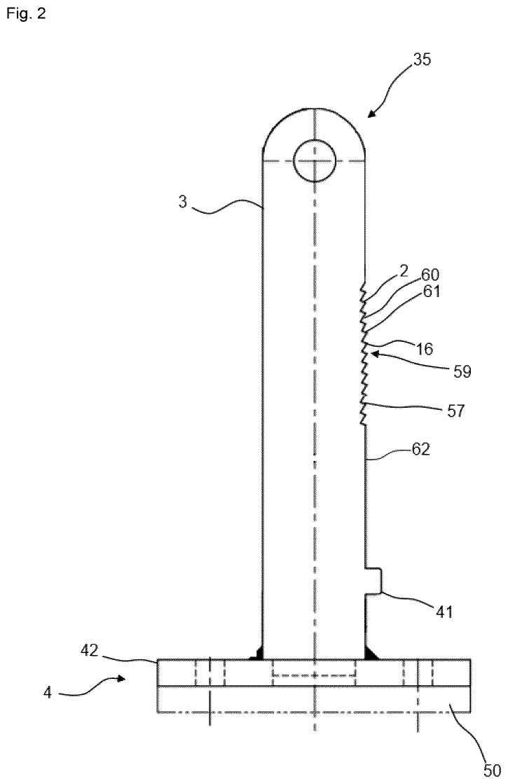

According to the invention, the shaft 3 comprises several notches 2 (or teeth) forming a notch 16 on the shaft 3 and therefore a notched shaft, as illustrated in FIGS. 1 and 2.

The displacement element 12 is intended to rest on one of the notches 2 when it is in its locking position to prevent the displacement element 12 from moving back in a direction opposite to the locking direction B.

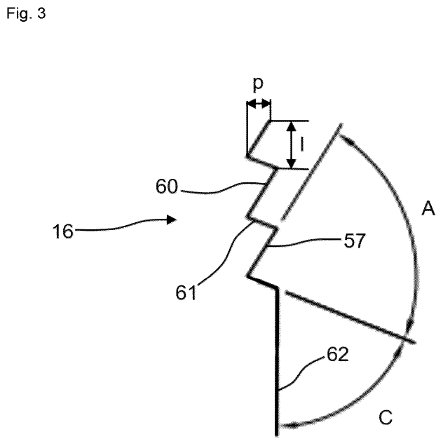

Each notch 2 comprises a first bearing face 60 and a second bearing face 61 forming a non-zero tooth angle A, as illustrated in the FIG. 3. The first support face 60 is oriented towards the foot 42 or the first end 4 of the shaft 3. The second bearing face 61 is oriented towards the second end 35 of the shaft 3.

Preferably, the tooth angle A is between 70° and 95°. The tooth angle A can be 85°, for example.

An angle C is formed between a non-notched face 62 of the shaft 3, adjacent to the first bearing face 60 of the notch 2, and the second bearing face 61 of the notch 2. Angle C is between 60° and 80°. Angle C is 69°, for example.

In the example of FIGS. 1 to 4, the notch 16 is oriented in a direction opposite to the handle 8. The shaft 3 comprises a first locking face 57 which is oriented towards a direction opposite to the handle 8, that is to say opposite to the trigger 9 and the edge 39 of the displacement element 12. The first blocking face 57 is oriented towards the structural element 55.

The notch 16 is positioned on a portion of the first locking face 57 or over the entire length of the first locking face 57.

When the handle 8 is actuated and the displacement element 12 is in the locking position, i.e. inclined non-perpendicularly relative to the shaft 3 to move the lever system 6 relative to the shaft 3, the first face 45 of the displacement element 12 comes to bear against the first bearing face 60 of the notch 2. When the door locking device 1 is positioned vertically on the ground, the first bearing face 60 of the notch 2 corresponds to an upper face.

The displacement element 12 is thus blocked by the first bearing face 60 of the notch 2 and cannot slide along the shaft 3. The lever system 6 is moved along the shaft 3 safely, without risk of slipping.

Alternatively (not shown), the notch 16 is oriented towards the handle 8. The shaft 3 comprises a second locking face 58 which is oriented towards the handle 8, that is to say towards the trigger 9 and the edge 39 of the displacement element 12. The second locking face 58 is opposite the first locking face 57 of the shaft 3.

According to this variant, when the displacement element 12 is in the locking position, that is to say inclined non-perpendicularly relative to the shaft 3 to move the lever system 6 relative to the shaft 3, the second face 46 of the displacement element 12 comes to bear against the second bearing face 61 of the notch 2. When the door locking device 1 is positioned vertically on the ground, the second bearing face 61 of the notch 2 corresponds to a lower face.

The displacement element 12 is thus blocked by the second bearing face 61 of the notch 2 and cannot slide along the shaft 3. The lever system 6 is moved along the shaft 3 without risk of slipping.

According to another variant (not shown), the shaft 3 comprises two opposite notches 16, a first notch 16 positioned on the first locking face 57 and a second notch 16 positioned on the second locking face 58.

According to this variant, when the displacement element 12 is in the locking position, that is to say inclined non-perpendicularly relative to the shaft 3 to move the lever system 6 relative to the shaft 3, the first face 45 of the displacement element 12 comes to bear against the first bearing face 60 of the notch 2 located on the first locking face 57. In parallel, the second face 46 of the displacement element 12 comes to bear against the second bearing face 61 of the notch 2 located on the second locking face 58.

The displacement element 12 is thus doubly blocked by the first bearing face 60 and the second bearing face 61 of the notch 2 and cannot slide along the shaft 3. The lever system 6 is moved along the shaft 3 even more securely, without the risk of slipping.

Whatever the embodiment, to move the shaft 3, the displacement element 12 cooperates either only with the notching 16 or with the notching 16 and a portion of the shaft 3 which is not notched (smooth).

The compression spring 15 surrounds the notch(s) 16.

In the example of FIGS. 1 to 4, shaft 3 has a rectangular section. The first locking face 57 and the second locking face 58 are positioned on the narrower sides of the shaft 3.

Shaft 3 has a width between 3 mm and 10 mm. The width of shaft 3 is 5 mm, for example.

The notching 16 extends over 20% to 60% of the length of the shaft 3, that is to say the length between the first end 4 and the second end 35 of the shaft 3.

The notching 16 may extend along the shaft 3 over a length corresponding to approximately 36% of the length of the shaft 3, for example.

Alternatively (not shown), the notching 16 can extend almost over the entire length of the shaft 3.

Thus, the notch 16 makes it possible to ensure better blocking for the displacement element 12 but also for the blocking element 17 of the blocking means 11.

The locking element 17 comprises a lower bearing surface which is oriented towards the displacement element 12. The lower bearing surface is locked against the second bearing face 61 of the notch 2 by the lever 18 when the lever 18 is in the locking position.

The notch 16 can include between 5 and 60 notches 2, for example. In the example of FIGS. 1 to 4, the notch 16 comprises 41 notches 2.

According to a variant, the notching 16 comprises a central zone 59 which is positioned between half and three-quarters of the length of the shaft 3, from the first end 4 of the shaft 3.

The notch 16 is closer to the second end 35 than to the first end 4 of the shaft 3. In other words, the shaft 3 comprises more notches 2 on the side of the second end 35 than on the first end 4.

Each notch 2 has a depth p between 0.5 mm and 1.5 mm. The depth p is 1 mm in the example of FIGS. 1 to 4.

Each notch 2 has a width I between 1 mm and 3 mm. The width I is 2 mm in the example of FIGS. 1 to 4.

These dimensions are given for a shaft 3 with a length of approximately 225 cm.

The FIG. 4 illustrates a variant in which the door locking device 1 comprises a magnetic plate 63 fixed on an external wall 64 of the door locking device 1.

The magnetic plate 63 is intended to be attached to a metal plate 65 provided on a support 66 hung on a wall, for example.

Thus, the support 66 and the door locking device 1 can advantageously be positioned near a door. In the event of an attack, the door blocking device 1 is quickly and easily accessible for use to block the door.

The metal plate 65 has an L-shaped section and comprises a support wall 67 on which rests a lower wall 68 of the door locking device 1.

The support wall 67 may comprise an orifice for the passage of the tab 7 of the lever system 6 and of the shaft 3.

The support 66 includes fixing holes 69 for fixing it to the wall.

The metal plate 65 is fixed to the support 66 by means of spacers 70.

Alternatively, the magnetic plate 63 can be fixed to the support 66.

The external wall 64 of the door locking device 1 being metallic, it attaches to the magnetic plate 63.

The structural element 55 of the lever system 6 comprises a front face intended to bear against a vertical face of the door when the door blocking device 1 blocks the door. The front face extends vertically when the door blocking device 1 is placed on the floor and blocking the door.

According to one variant, the front face of the structural element 55 is at least partially covered with a layer of rubber.

The tab 7 comprises an upper face intended to bear against a lower face of the door positioned below the door when the door locking device 1 locks the door. The upper face extends horizontally when the door blocking device 1 is placed on the floor and blocking the door.

According to another variant, the upper face of the tab 7 is also covered at least partially with a layer of rubber.

Alternatively, only the upper face of the tab 7 comprises a layer of rubber.

The rubber layer can be polyurethane, for example. The rubber layer can have a thickness between 0.3 cm and 1 cm, for example.

The rubber layer(s) prevent the lever system 6 and/or the tab 7 from sliding along the door when the door is locked by the door locking device 1. The rubber layer(s) have an anti-slip function.

1. A door locking device for keeping a door closed, comprising a shaft having a first end configured to rest on the ground and a lever system movable in translation relative to the shaft, the lever system comprising a tab configured to be positioned under the door and a handle provided with a trigger connected to an actuating device for moving the lever system relative to the axle towards a direction (B) for locking the door, the actuating device comprising a displacement element held on the shaft by return means, the displacement element being pivotable relative to the shaft between a rest position in which it is substantially perpendicular to the shaft so as to allow free translation of the lever system on the shaft and a locking position in which the displacement element is inclined non-perpendicularly relative to the shaft to move the lever system relative to the shaft, the locking position being obtained by actuation of the trigger causing the pivoting of a first end of the trigger towards the displacement element and pressure on an edge of the displacement element to tilt it non-perpendicularly relative to the shaft and lock it on the shaft, prolonged actuation of the trigger causing the translation of the lever system relative to the shaft towards the locking direction (B) of the door by the thrust of the first end of the trigger on the displacement element, the lever system comprising locking means to lock it relative to the shaft and hold the door closed, the shaft comprising several notches forming a notch, the displacement element being configured to rest on one of the notches when the displacement element is in the locking position.

2. The door locking device according to claim 1, wherein the notch is oriented in a direction opposite to the handle.

3. The door locking device according to claim 1, wherein the notch is oriented towards the handle.

4. The door locking device according to claim 1, wherein the notching extends over 20% to 60% of the length of the shaft.

5. The door locking device according to claim 1, wherein the notching comprises a central zone positioned between half and three quarters of the length of the shaft, from the first end of the shaft.

6. The door locking device according to claim 5, wherein the shaft comprises a second end opposite the first end, and the notching being closer to the second end than to the first end of the shaft (3).

7. The door locking device according to claim 1, wherein each notch has a depth p of between 0.5 mm and 1.5 mm.

8. The door locking device according to claim 1, wherein each notch has a width I of between 1 mm and 3 mm.

9. The door locking device according to claim 1, wherein each notch comprises a first bearing face and a second bearing face forming a tooth angle A of between 70° and 95°.

10. The door locking device according to claim 9, wherein an angle C is formed between a non-notched face of the shaft, adjacent to the first bearing face of the notch, and the first bearing face of the notch, the angle C being between 60° and 80°.
